(19) United States
(12) Patent Application Publication
(10) Pub. No.: US 2026/0102955 A1
(43) Pub. Date: Apr. 16, 2026

(54) INJECTION UNIT FOR A MOLDING MACHINE, A MOLDING MACHINE HAVING SUCH AN INJECTION UNIT AND A METHOD FOR DETERMINING A PRESSURE LOSS OF AN INJECTION UNIT

(71) Applicant: ENGEL AUSTRIA GmbH, Schwertberg (AT)

(72) Inventors: Paul Joachim Wagner, Asten (AT); Stefan Kleindel, Linz (AT)

(21) Appl. No.: 19/358,292

(22) Filed: Oct. 14, 2025

(30) Foreign Application Priority Data
Oct. 15, 2024 (AT) A 50829/2024

(51) Int. Cl. B29C 45/47; B29C 45/77

(52) U.S. Cl. CPC B29C 45/47; B29C 45/77; B29C 2945/76066; B29C 2945/76692

(57) ABSTRACT

An injection unit for a molding machine, including a mass cylinder, an injection actuator, which injection actuator is configured to expel a plasticized molding compound from the mass cylinder via an injection nozzle, at least one sensor which is configured to detect a time-resolved, characteristic signal for the driving force of the injection actuator, and an open or closed loop control device for open or closed loop control of the injection actuator, which open or closed loop control device is configured to receive the time-resolved, characteristic signal of the at least one sensor. The open or closed loop control device is configured to carry out the following steps: controlling the injection actuator to perform a movement towards the injection nozzle, recording the time-resolved signal characteristic of the driving force of the injection actuator, determining a substantially constant force level for a period of time, preferably before a significant increase in injection force level follows, and preferably calculating the pressure loss (Δp) based on the first force level.

### CROSS-REFERENCE TO RELATED APPLICATION

This application claims priority to and benefit of AT Application No. A 50829/2024, filed on Oct. 15, 2024, entitled “INJECTION UNIT FOR A MOLDING MACHINE, A MOLDING MACHINE HAVING SUCH AN INJECTION UNIT AND A METHOD FOR DETERMINING A PRESSURE LOSS OF AN INJECTION UNIT”, which is herein incorporated by reference in its entirety for all purposes.

### BACKGROUND

The present disclosure relates to an injection unit for a molding machine having the features of the preamble of claim 1, a molding machine having such an injection unit, a method for determining a pressure loss of an injection unit, as well as a corresponding computer program product and a computer-readable storage medium.

Molding machines can include injection molding machines, injection presses, die casting machines, presses and the like. Molding machines in which the plasticized molding compound is fed into an open mold are also conceivable.

In the following, the prior art shall be outlined in the case of an injection molding machine. This analogously applies generally to molding machines.

Generic injection units for injection molding machines comprise:
a mass cylinder,
an injection actuator, which injection actuator is designed to expel a plasticized molding compound from the mass cylinder via an injection nozzle,
at least one sensor which is designed to detect a time-resolved, characteristic signal for the driving force of the injection actuator, and
an open or closed loop control device (e.g., controller) for open or closed loop control of the injection actuator, which open or closed loop control device is designed to receive the time-resolved, characteristic signal of the at least one sensor.

For the precise control and optimization of a process in a molding machine, especially an injection molding machine, it is necessary to determine injection forces.

The injection forces can be used to calculate the injection pressures in a molding compound that is fed into a mold and to adapt them to the process or the mold.

Nowadays, it is already common practice from the state of the art to calculate and optimize the filling process (the injection process) using simulation programs in order to optimally fill molds, so that not only a production cycle can be optimized in terms of productivity, but also the quality of a produced molded part can be improved by adjusting the injection movement, the injection pressures and the injection speed.

In order to be able to implement the desired injection process in a mold on the injection molding machine, it is therefore necessary to be able to determine injection forces or injection pressures as accurately as possible so that an injection movement can be open or closed loop controlled on the basis of these measured values.

In most cases, so-called measuring diaphragms are used for this purpose, which, due to their positioning between the injection actuator and the injection element, can detect an axial driving force of the injection actuator acting in the direction of the expulsion movement of the plasticized material from the mass cylinder.

Such a measuring diaphragm is known, for example, from DE 10 2019 135281 B4.

Alternatively, it is also known from the prior art for injection units which have a hydraulic injection actuator to use the hydraulic pressures present in the injection actuator and to determine the effective driving force of the injection actuator based thereon.

This driving force is usually recorded in a time-resolved manner over the injection process and is referred to as injection force or injection force level.

Due to the known dimensions of the injection unit, the mass cylinder and the injection element acting therein (for example an injection screw), this driving force is then usually converted into a pressure level, which is equated with the injection pressure of the injection molding machine for open or closed loop control by the open or closed loop control device (e.g., controller) of the injection unit. In principle, however, it is of course also possible to open or closed loop control the injection unit based on the injection force.

However, it has been found that such an approach can lead to significant systematic errors, as pressure losses can occur due to friction in the mass cylinder.

Such pressure losses are therefore due to deviations between the driving force exerted by the injection actuator and the actual injection pressure and/or the actual injection force exerted.

Corresponding deviations can also be tracked using measurement technology, for example by arranging additional pressure sensors in the area of the injection nozzle, which record the actual injection pressure.

However, a corresponding measuring arrangement for measuring the actual injection pressure is very complex, requires large resources and cannot be used in many situations due to lack of space or manufacturing conditions (high temperatures). Furthermore, such measuring technology usually has a short service life, as the high forces acting and the high temperatures occurring lead to damage or rapid wear of the (usually quite expensive) measuring technology.

However, since the optimization of the injection pressure is becoming increasingly important—especially with regard to high-precision molded parts—there is a desire to be able to determine the injection pressure more precisely while still requiring little measurement effort.

### BRIEF DESCRIPTION

The object is to provide an injection unit as well as a method and a computer program product with which the previously described disadvantages of the prior art can be at least partially improved and/or a more reliable and/or more accurate possibility of determining an injection pressure is created.

This object is achieved by an injection unit for a molding machine having the features of claim 1, a molding machine having such an injection unit, a method for determining a pressure loss of an injection unit of a molding machine having the features of claim 11, a computer program product having the features of claim 12, and a computer-readable storage medium.

A first exemplary embodiment of an injection unit for a molding machine comprises:
A mass cylinder,
an injection actuator, which injection actuator is designed to expel the plasticized molding compound from the mass cylinder via an injection nozzle,
at least one sensor which is designed to detect a time-resolved, characteristic signal for the driving force of the injection actuator, and
an open or closed loop control device (e.g., controller) for open or closed loop control the injection actuator, which open or closed loop control device is designed to receive the time-resolved, characteristic signal of the at least one sensor,
wherein the open or closed loop control device (e.g., controller) is designed to carry out the following steps:
controlling the injection actuator to perform a movement towards the injection nozzle,
recording the time-resolved signal characteristic of the driving force of the injection actuator,
determining a substantially constant force level for a period of time, preferably before a significant increase in injection force level follows, and
preferably calculating the pressure loss based on the first force level.

This exemplary embodiment thus makes it possible to determine a pressure loss and/or the substantially constant force level via an existing sensor which is designed to detect a time-resolved, characteristic signal for the drive force of the injection actuator, wherein this pressure loss and/or the substantially constant force level can be used as a correction parameter in the subsequent operation and/or in the evaluation of an injection process and/or in the open or closed loop control of the injection unit in order to adapt the determined measured values to an actually existing injection pressure or injection force.

It is possible to determine the actual injection pressures and injection forces by using existing resources without having to use additional, complex and wear-sensitive measuring technology.

By determining an actual injection pressure or injection force, a much greater variability in production is achieved, meaning that, for example, a mold can be used on different molding machines and the same parameter can be set without having to take machine-specific distortions into account.

In addition, it is possible to directly determine, adjust, open or closed loop control of the injection pressures and injection forces, so that, for example, actual production can be easily adapted to a simulation, or vice versa.

Furthermore, an injection process can be better monitored by eliminating unknown pressure losses. In this way, the injection force level, excluding pressure loss, can be used to obtain more precise and detailed information about the start, end and course of the injection process.

Furthermore, this more precise and sensitive ability to determine injection forces and injection pressures makes it possible to better analyze the injection process in a time-resolved manner, wherein changes in injection pressures and/or injection forces can be identified earlier as a result of wear or failure of components.

The actual injection force and/or the actual injection pressure can preferably result as the difference between a measured driving force or a pressure corresponding to the driving force and the determined essentially constant force level or the pressure loss.

The essentially constant force level can be understood to mean that the detected driving force does not leave a predetermined range around the force level over the period of time, wherein the predetermined range is defined, for example, by a maximum deviation from the force level.

The maximum deviation from the essentially constant force level can depend on various factors, such as the ability of the molding machine or the injection unit to accurately realize specified movements or properties of the raw material, such as the hardness of a plastic granulate.

Preferably, the maximum deviation of the substantially constant force level is less than 15%, preferably 10%, particularly preferably 5%, of the substantially constant force level.

It should be noted that there is initially no restriction on the length of time over which the force level is essentially constant. The length of the time period is usually determined by the length of time for which the injection actuator executes the movement in the direction of the injection nozzle, wherein a start-up time and a possible pressure increase after the phase of essentially constant pressure also play a role.

Detecting the characteristic signal can be understood as receiving the characteristic signal and using it either directly or in a manner that preserves the characteristic quality to determine the substantially constant force level.

Protection is also sought for a molding machine, in particular an injection molding machine, with an injection unit according to the first exemplary embodiment.

Molding machines can include injection molding machines, injection presses, presses and the like. Molding machines in which the plasticized molding compound is fed into an open mold are also conceivable.

A device or method according to the invention can also be used in already known embodiments of the prior art, as already described in the introduction to the specification, and can be installed subsequently.

In other words, the features described with reference to the prior art can of course also be implemented in combination with the invention.

The open or closed loop control device (e.g., controller) of the injection unit can also be designed as a central open or closed loop control device of a molding machine or form part thereof.

Physically, the open or closed loop control device (e.g., controller) can be designed as a separate computer at the production site or as a cloud server. Another alternative would be for the open or closed loop control device to be integrated into an open or closed loop machine control system of a molding machine. The control or regulation device can also be realized by a combination of the mentioned possibilities and/or distributed computing.

The statements contained herein with regard to the open or closed loop control device (e.g., controller) also apply mutatis mutandis to the computer program product.

Advantageous embodiments are defined in the dependent claims.

It is preferably provided that the at least one sensor which is designed to detect a time-resolved characteristic signal for the driving force of the injection actuator comprises a strain gauge measuring strip and/or a piezo sensor.

Preferably, it can be provided that the at least one sensor, which is designed to detect a time-resolved characteristic signal for the drive force of the injection actuator, cooperates with a measuring diaphragm, which measuring diaphragm is arranged in terms of force flow between the drive actuator and an injection element, in particular an injection screw or an injection piston.

The arrangement in terms of force flow between the drive actuator and the injection element can be understood here as meaning that the arrangement is such that the force flow leads—preferably exclusively—from the drive actuator through the measuring diaphragm and further to the injection element. It does not necessarily have to be a geometric arrangement between the drive actuator and the injection element, although this can of course still be the case.

For example, it can be provided that a measuring diaphragm is designed according to DE 10 2019 135281 B4.

Preferably, it can be provided that the at least one sensor is designed in such a way that a drive power of the injection actuator is determined and, via this drive power, a time-resolved characteristic signal for the drive force exerted by the injection actuator is output.

It may also be provided that the at least one sensor is designed in such a way that an operating state of the injection actuator is determined and a time-resolved signal characteristic of the drive force exerted by the injection actuator is output via this operating state. For example, in the case of an electrically driven injection actuator, a motor current and/or in the case of a hydraulically driven injection actuator, a hydraulic pressure could serve as an operating variable for determining a time-resolved characteristic signal for the drive force exerted by the injection actuator.

It can be provided that the open or closed loop control device (e.g., controller) uses a geometrical condition of the injection unit to calculate the pressure loss on the basis of the first force level, wherein, for example, a cross-sectional area of the mass cylinder or the injection nozzle can be used to convert the force level to a corresponding prevailing pressure.

Of course, design variants are also conceivable in which relationships between force and pressure are stored as parameters in the open or closed loop control device (e.g., controller) or can be made available to the open or closed loop control device.

It can be provided that the open or closed loop control device (e.g., controller) is designed to control the injection actuator to move by a defined length in an opposite direction before detecting the characteristic signal and before moving in the direction of the injection nozzle, wherein ambient air of the mass cylinder is preferably sucked into the area in the mass cylinder between the injection actuator and the injection nozzle.

At least along a partial area of this defined length, the constant force level, which is used to determine the pressure loss, can be established, since precisely in this area only the frictional resistances, which cause the pressure loss, act on the injection actuator during a subsequent movement in the direction of the injection nozzle.

By “pulling back” the injection actuator by a defined length, it can be ensured that a sufficient area in the mass cylinder is not filled with plasticized molding compound, in which area the injection actuator can move freely in a subsequent movement towards the injection nozzle to record the time-resolved signal characteristic of the driving force of the injection actuator, without exerting pressure on the plasticized molding compound—in other words: a defined length is provided in which air can be expelled from the mass cylinder before the plasticized molding compound in the mass cylinder is compressed.

A correspondingly defined length can also be referred to in professional circles as generously chosen compression relief (or K-relief for short).

Preferably, it is provided that the defined length by which the injection actuator is retracted in an opposite direction to the injection nozzle corresponds to at least 0.5 times an inner diameter of the mass cylinder in the region of the injection actuator.

It can be provided that the defined length corresponds to a maximum of the structurally possible retraction of the injection actuator. However, the larger the defined length is chosen, the longer the time period for determining a pressure loss of the injection unit becomes.

For example, it may be provided that during the movement of the injection actuator in a direction opposite to the injection nozzle, the injection nozzle is closed so that—at least substantially—no ambient air is sucked into the mass cylinder.

It can be provided that the determination of a force level that is essentially constant for a period of time is carried out in the course of a data evaluation in a range between the end of a compression release (or K-release for short) and the end of a dosing process (the introduction, production or provision of the plasticized molding compound in the mass cylinder), whereby the data in this period are preferably shortened somewhat at the beginning and end (in particular so that the start-up effect and the pressure increase upon impact with the compound do not falsify the result).

Preferably, it can be provided that the open or closed loop control device (e.g., controller) is designed to detect the time-resolved signal characteristic of the driving force of the injection actuator during the movement of the injection actuator in the direction of the injection nozzle.

It can be provided that the open or closed loop control device (e.g., controller) is designed to detect the time-resolved, characteristic signal during a constant movement of the injection actuator in the direction of the injection nozzle at a defined speed.

It can be provided that the open or closed loop control device (e.g., controller) is designed to detect a plurality of time-resolved, characteristic signals for the driving force of the injection actuator at different, defined speeds of the injection actuator for the movement in the direction of the injection nozzle, preferably to determine a force level that is essentially constant for a period of time at each defined speed, and particularly preferably to calculate a pressure loss on the basis of each force level for each defined speed.

Tests conducted by the applicant have shown that different pressure losses occur depending on the injection speed. This is due to the fact that frictions that occur have a strong correlation with the set speed.

In order to determine an exact pressure loss, it is recommended to record a time-resolved, characteristic signal for the driving force of the injection actuator for a defined speed (which is also used during the subsequent production cycle) and to use this to determine the corresponding pressure loss via the constant force level.

Other parameters that have a major influence on the pressure level are, of course, temperature, type and composition of the plasticized molding compound. In principle, all factors that affect the viscosity of the plasticized molding compound, preferably the plasticized plastic, can have an influence on the pressure level. These include the molding compound itself (e.g., average molecular weight, fillers, etc.), as well as temperature, residual moisture, masterbatches, shear rate and sometimes also the prevailing pressure. In addition, there are, for example, friction values between a granulate and a mass cylinder (provided the molding compound is in an initial form as a granulate).

It can also be provided that the open or closed loop control device (e.g., controller) is designed to display the detected pressure losses for several different defined speeds by means of a diagram and/or an algorithm.

Such a diagram and/or such an algorithm, which represents a relationship between the pressure loss and a speed of the injection actuator, can be stored, for example, in the open or closed loop control device (e.g., controller) and, as required, a corresponding pressure loss can be read out via the algorithm and/or the diagram and taken into account for the open or closed loop control of the injection unit.

Preferably, it can be provided that the diagram and/or the algorithm, in particular a formula derived therefrom, represents a relationship between the injection speed and a resulting pressure loss for the injection unit.

It can be provided that the open or closed loop control device (e.g., controller) is designed to supply a defined amount of plasticized plastic to the mass cylinder before the detection of the characteristic signal and before the movement of the injection actuator in the direction of the injection nozzle, preferably to plasticize it by an open or closed loop control rotary movement of an injection screw and to collect it between the injection actuator and the injection nozzle.

Preferably, it can be provided that the injection actuator is designed to drive an injection piston and/or an injection screw linearly along a longitudinal axis in the mass cylinder for expelling the plasticized molding compound.

It can be provided that the open or closed loop control device (e.g., controller) is designed to detect and calculate the pressure loss during
ongoing operations, in particular ongoing production using the injection unit,
a plasticized molding compound in the mass cylinder is fed into a free space via the injection nozzle through the injection actuator, and/or
a plasticized molding compound is compressed into a mass cushion in the mass cylinder with the injection nozzle closed.

It can be provided that the open or closed loop control device (e.g., controller) is designed to take the pressure loss into account in a subsequent open and/or closed loop control of the injection unit, particularly preferably of the injection actuator, preferably to take the pressure loss into account when determining the injection force level.

The open or closed loop control during the injection process can be open or closed loop controlled at least temporarily according to the injection force and/or the injection pressure, particularly preferably after a speed-controlled phase.

Furthermore, protection is sought for a method for determining a pressure loss in an injection unit of a molding machine, preferably an injection unit according to the first exemplary embodiment, wherein the injection unit has a mass cylinder and an injection actuator, which injection actuator is designed to expel a plasticized molding compound from the mass cylinder via an injection nozzle, comprising the following method steps:
Moving the injection actuator towards the injection nozzle,
recording a time-resolved signal characteristic of the driving force of the injection actuator
determining a substantially constant force level for a period of time, preferably before a significant increase in injection force level follows, and
preferably calculating the pressure loss based on the first force level.

Furthermore, protection is sought for a computer program product comprising instructions which, when the program is executed by an open or closed loop control device (e.g., controller) of an injection unit, preferably the first embodiment of an injection unit, carry out the following steps:
controlling the injection actuator to perform a movement towards the injection nozzle,
recording a time-resolved signal characteristic of the driving force of the injection actuator,
determining a substantially constant force level for a period of time, preferably before a significant increase in injection force level follows, and
preferably calculating the pressure loss based on the first force level.

Protection is also sought for a transitory or non-transitory computer-readable storage medium on which a computer program product according to the invention is stored.

“Defined” variables, for example the defined length and/or the defined speed, can preferably be understood as at least one value of the respective variable that is predetermined and/or stored and/or programmed in the open or closed loop control device.

### BRIEF DESCRIPTION OF THE DRAWINGS

Further details and advantages of the present disclosure are explained in more detail below with reference to the embodiments shown in the figures. In particular:

FIG. 1 shows an exemplary embodiment of a molding machine,

FIG. 2 shows an exemplary test setup on an injection unit,

FIG. 3 shows an evaluation of an injection process,

FIG. 4 shows several evaluations of an injection process with different injection speeds,

FIG. 5 shows a visual representation of the pressure losses determined from FIG. 4, and

FIGS. 6-9 show a comparison of determined pressures compared to the standard method.

### DETAILED DESCRIPTION

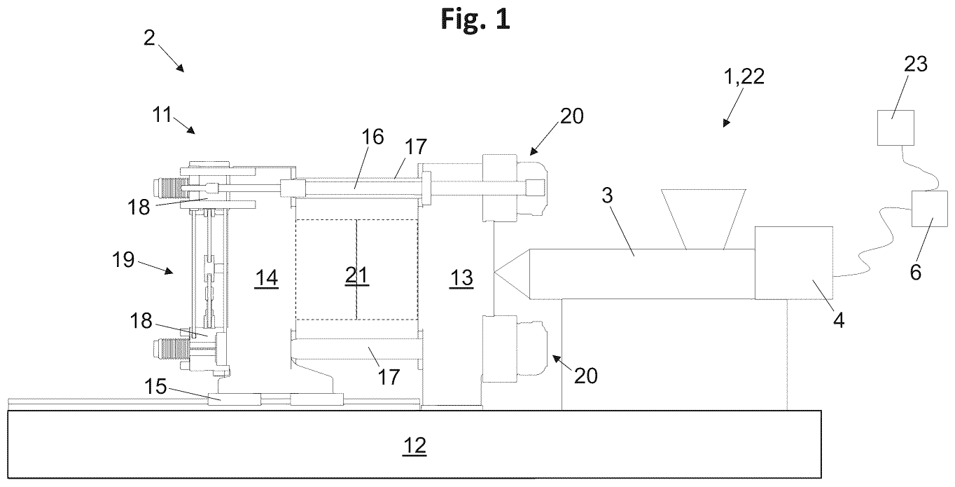

The molding machine 2 shown as an example in FIG. 1 has an injection unit 1 and a clamping unit 11, which are arranged together on a machine frame 12. The machine frame 12 could alternatively be constructed in several parts.

The illustrated clamping unit 11 is, according to an exemplary embodiment of a clamping unit 11 known from the prior art for a molding machine 2.

This embodiment of FIG. 1 is designed as a two-plate clamping unit 11.

The fixed mold clamping plate 13 is arranged stationary on the machine frame 12, whereas the movable mold clamping plate 14 is mounted on the machine frame 12 in a sliding manner relative to the fixed mold clamping plate 13 by means of the guide device 15.

The guide device 15 can be designed, for example, as a sliding and/or rail guide.

The movable mold clamping plate 14 can be moved for opening and closing by means of a piston-cylinder unit 16 (which serves as a rapid lifting device).

In order to apply a closing force between the fixed mold clamping plate 13 and the movable mold clamping plate 14, the movable mold clamping plate 14 is locked relative to the fixed mold clamping plate 13 via the bars 17 and the locking device 19 having the locking nuts 18.

In this embodiment, the locking nuts 18 are arranged on the fastening side of the movable mold clamping plate 14.

The bars 17 of this embodiment are connected to the fixed mold clamping plate 13 via the clamping force mechanisms 20 having the pressure pads.

After locking the movable mold clamping plate 14 relative to the fixed mold clamping plate 13, a tensile force can be transmitted to the bars 17 via the pressure pads on the fixed mold clamping plate 13, which bars 17 pull the movable mold clamping plate 14 relative to the fixed mold clamping plate 13 via the locking nuts 18 and thus exert a closing force and/or a compressive force on a mold 21 which can be arranged between the mold clamping plates 13, 14.

Mold halves of a mold 21 can be clamped or mounted on the fixed mold mounting plate 13 and the movable mold mounting plate 14 (shown dashed).

The mold 21 shown closed in FIG. 1 has at least one cavity. An injection channel leads to the cavity, via which a plasticized molding compound can be fed to the injection unit 1.

It should be noted, however, that the exact design of the clamping unit and the molding tool 21 is not critical for the present disclosure. For example, the present disclosure may also be practiced with three-platen clamping units or C-frame clamping units.

The injection unit 1 of this exemplary embodiment has a mass cylinder 3 and an injection screw 9 arranged in the mass cylinder 3. This injection screw 9 can be rotated about its longitudinal axis 10 and moved axially along the longitudinal axis 10 in the conveying direction.

These movements are driven by an injection actuator 4, shown schematically. Preferably, the injection actuator 4 comprises a rotary drive for the rotary movement and a linear drive for the axial injection movement.

FIG. 1 shows a molding machine 2 with an injection unit 1, wherein the injection unit 1 shown in this exemplary embodiment has an injection screw 9, which is also used for plasticizing a material to be plasticized (and thus also forms the plasticizing unit 22 of the molding machine 2).

The plasticizing unit 22 (and thus the injection unit 1) is in signal connection with an open or closed loop control device 6. Control commands are output from the open or closed loop control device 6 (e.g., controller) to the plasticizing unit 22 and thus to the injection unit 1.

The open or closed loop control device 6 can be connected to an operating unit and/or a display device 23 or be an integral part of such an operating unit.

In this embodiment, the open or closed loop control device 6 of the injection unit 1 is designed as a central machine control of the molding machine 2. However, it is also entirely conceivable for the open or closed loop control device 6 of the injection unit 1 to be designed separately from the central machine control of the shaping machine 2, preferably wherein the open or closed loop control device 6 and the central open or closed loop machine control of the molding machine 2 can be connected by means of a data transfer connection.

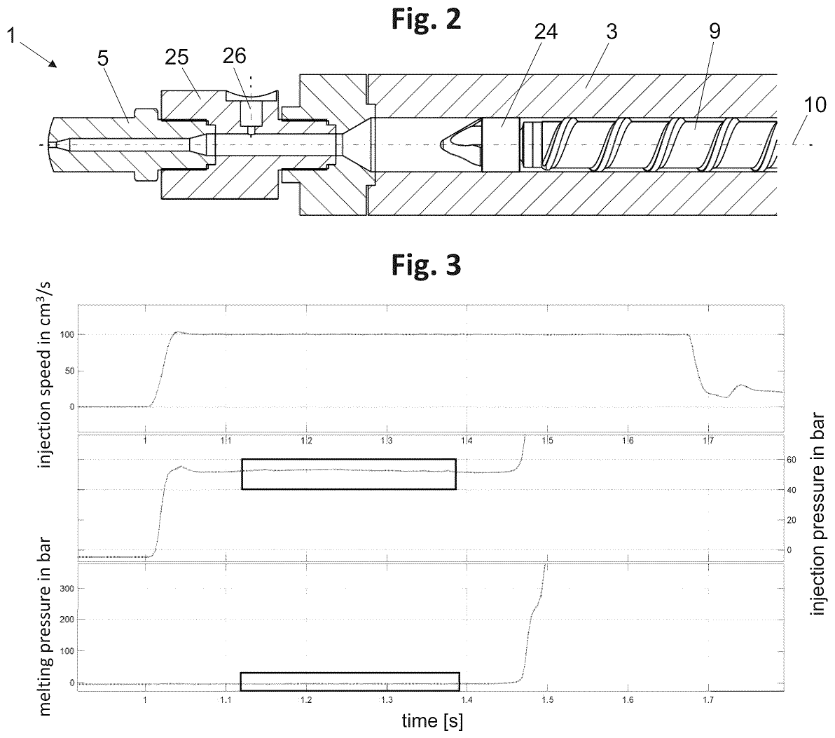

FIG. 2 shows an exemplary setup for a test measurement on an injection unit 1.

This injection unit 1 comprises an injection screw 9, which is mounted so as to be rotatable about and axially displaceable along the longitudinal axis 10.

The injection screw 9 can be driven via the injection actuator 4 and further comprises a non-return valve 24 known from the prior art, which is designed to allow the material flow of a plasticized molding compound from the injection screw 9 into the space formed between the injection nozzle 5 and the injection screw 9 during a dosing process and to prevent the backflow of the plasticized molding compound towards the injection screw 9 during an injection process.

The injection screw 9 is mounted in the mass cylinder 3.

In this exemplary embodiment, a driving force of the injection actuator 4 is determined by a common measuring diaphragm (as is known, for example, from DE 10 2019 135281 B4) and a sensor arranged thereon and its detected characteristic signal.

Furthermore, an additional measuring flange 25 is provided in this measuring setup, which is arranged between the mass cylinder 3 and the injection nozzle 5.

This measuring flange 25 comprises a receptacle 26 for a pressure sensor (which sensor is not shown for reasons of clarity).

This sensor can be used to directly determine the pressure of the plasticized molding compound applied to the injection nozzle 5, which is representative of an injection pressure of the injection unit 1.

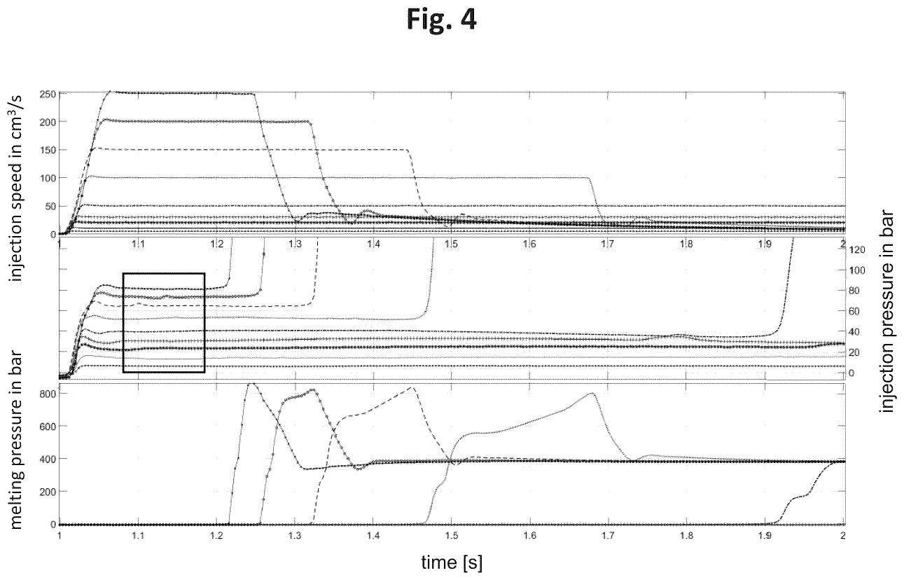

FIG. 3 shows an evaluation of an injection process measured by a test setup as shown in FIG. 2.

First (not yet visible in the diagram of FIG. 3), plasticized molding compound is conveyed by the injection screw 9 via the non-return valve 24 into the screw antechamber, in that a material to be plasticized is plasticized by a rotational movement of the injection screw 9 about the longitudinal axis 10 and passes as plasticized molding compound via the non-return valve 24 into the screw antechamber.

It is known from the prior art that during this plasticization the injection screw 9 is released for a longitudinal movement along the longitudinal axis 10, whereby the injection screw 9 is pressed or displaced into a side facing away from the injection nozzle 5 by the plasticized molding compound conveyed into the screw antechamber.

As soon as a desired amount of plasticized molding compound has collected in the screw antechamber (between injection screw 9 and injection nozzle 5), a so-called compression relief is carried out.

During this compression relief, the injection screw 9 is actively distanced further from the injection nozzle 5 by a defined length via the injection actuator 4, so that a minimal pressure on the plasticized molding compound in the screw antechamber, which has been formed during plasticization, is reduced or this pressure is dissipated.

This retraction by a defined length is further increased in this measurement test so that a pressure relief on the molding compound present in the screw antechamber can definitely be expected and, in addition, a certain area is formed in the screw antechamber, which is filled by air sucked in from the environment.

Subsequently, the test procedure shown in FIG. 3 is carried out and the injection screw 9 is moved in the direction of the injection nozzle 5 according to the speed profile of the top table of FIG. 3 by appropriately open or closed loop controlling the open or closed loop control device 6 of the injection actuator 4.

During this open or closed loop controlled movement of the injection screw 9 via the injection actuator 4, the pressure curves of the molding compound conveyed via the injection nozzle 5 are determined.

These pressure curves are determined on the one hand via the sensor for determining the characteristic signal for the driving force of the injection actuator 4 on the measuring diaphragm and on the other hand via the pressure sensor arranged in the measuring flange 25.

The pressure curve shown in the middle of FIG. 3 shows the result of the measurement via the drive force of the drive unit 4 and the pressure curve shown in the lower part of the diagram in FIG. 3 shows the result of the measurement of the pressure sensor which is arranged in the measuring flange 25.

As can be seen from the comparison of these two pressure curves, a different pressure curve can be seen between seconds 1 and 1.5, wherein in the measurement via the drive unit a pressure increase can already be determined in this area, which remains between seconds 1.1 and 1.45 at an essentially constant pressure level resulting from an essentially constant determined force level of the drive unit 4, before the pressure increases significantly as a result of the injection force level.

However, such an essentially constant force level (or such a plateau) cannot be detected by the pressure curve determined by the sensor in the measuring flange 25.

These areas are illustrated in FIG. 3 by the rectangles.

This difference is due to the realization that the injection screw 9, the non-return valve 24 and the injection actuator 4 are subject to friction and losses, which means that when measuring the drive force of the injection actuator 4, the power loss is naturally also measured.

However, if an injection unit is subsequently open or closed loop controlled solely by measuring a driving force of the injection actuator 4, the problem arises that this loss is incorporated into the open or closed loop control of the injection unit 1, which naturally leads to a falsification.

This difference becomes particularly apparent when comparing the process of injection unit 1 with a simulation, meaning that parameters of a simulation cannot be trivially transferred to a physical injection unit 1.

Process parameters of one injection unit 1 cannot be easily transferred to another injection unit 1, for example if a mold is exchanged between injection molding machines.

However, during normal operation of the injection unit 1, it is also not a solution to operate a measuring flange 25 with a pressure sensor, since corresponding pressure sensors exhibit quite high wear due to the high pressures and the high temperatures involved, which would of course have a massive impact on the maintenance interval and process reliability of an injection unit 1. In addition, corresponding measuring systems and sensors involve increased installation effort and increased costs.

Therefore, there is a desire to be able to achieve essentially the same measurement result by measuring a characteristic signal for the driving force of the injection actuator 4 as by a pressure sensor in the measuring flange 25, which measurement results reflect the actual injection pressure of the plasticized molding compound.

This is achieved by the knowledge explained in FIG. 3, wherein the essentially constant force level, which results from the friction and losses of the movement of the injection screw 9, is determined and further evaluated by calculation into a pressure loss Δp, which pressure loss Δp can be used in the further process of the injection unit 1 for the open or closed loop control or the evaluation of the injection actuator 4.

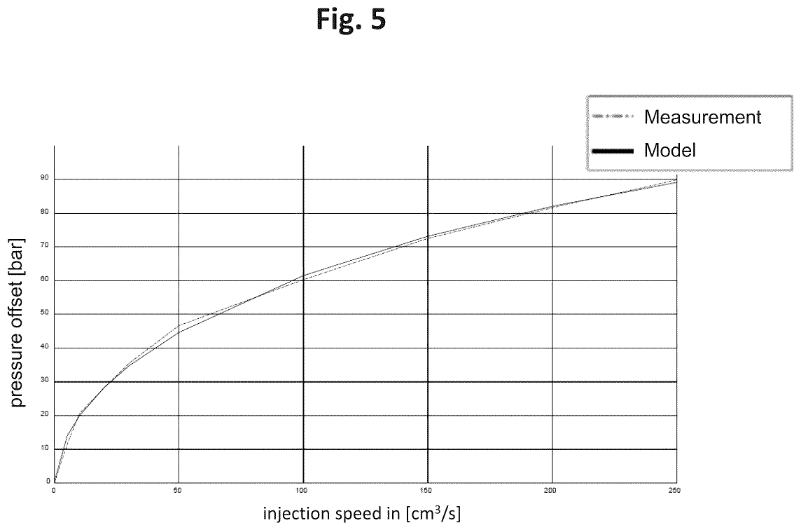

The magnitude of this pressure loss Δp is strongly dependent on the injection speed, as illustrated in FIG. 4.

This FIG. 4 shows essentially the same evaluation as FIG. 3, although in FIG. 4 several evaluations were carried out with different injection speeds.

It can be seen that the higher the injection speed, the higher the plateau is formed, in which an essentially constant force level can be observed before the significant increase in the injection force level.

From this essentially constant force level, pressure losses Δp can then be calculated as a function of the injection speeds.

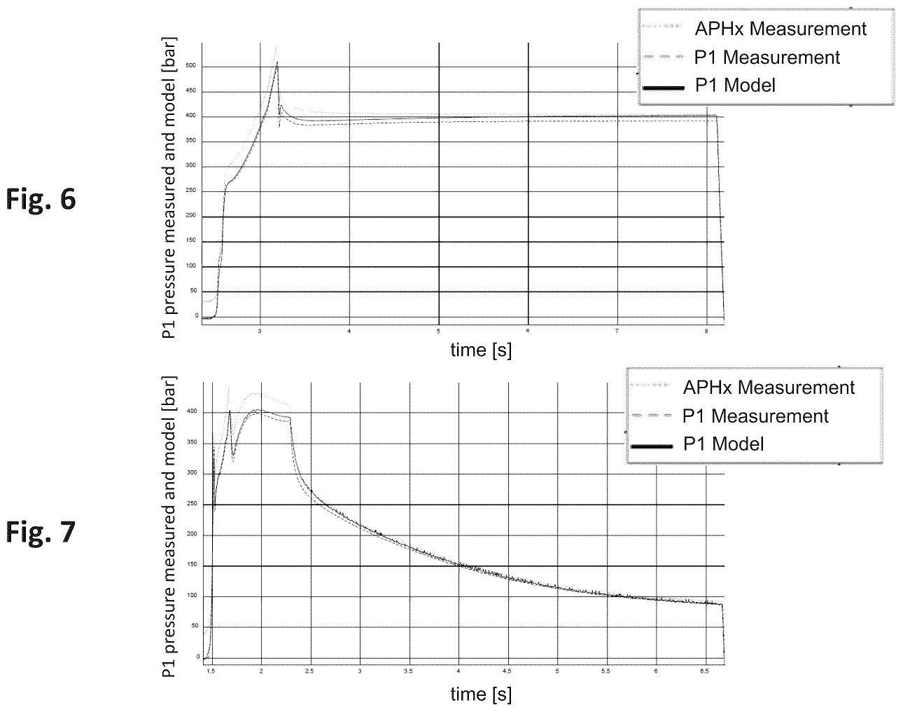

If the pressure losses Δp thus determined are plotted against the injection speed, the curve shown in FIG. 5 is obtained.

This relationship can be described very simply with the following equation:

$$Δ p = a + b \dot{V} + c {\dot{V}}^{n}$$

Where Δp_{f} is the desired pressure loss, \dot{V} is the volume flow (calculated from the injection speed and the geometric properties of the injection unit 1) and a, b, c and n are fitted parameters.

This simple model only takes into account the friction in the system and no inertial effects that occur when the injection screw 9 is accelerated by the injection actuator 4.

The accelerated mass can be identified or estimated with sufficient accuracy using the measurements described, or it is known from dry-running tests, or it can be calculated using design data.

With the accelerated mass, the inertial effect can be taken into account as follows:

$$Δ {p}_{dyn} = ma / A$$

wherein Δ=ma/A represents the accelerated mass, is the instantaneous acceleration and is the cross-sectional area of the mass cylinder 3.

The inertia effect plays only a minor role and could be neglected, for example, in the case of highly viscous molding compounds due to its small influence on the total pressure loss Δp.

The actual pressure or injection pressure pₘₑₗₜ at the injection nozzle 5 can then be calculated as follows from the injection pressure p_{inject} determined from the characteristic signal for the driving force of the injection actuator 4:

$${p}_{melt} = {p}_{inject} - Δ {p}_{f} - Δ {p}_{dyn}$$

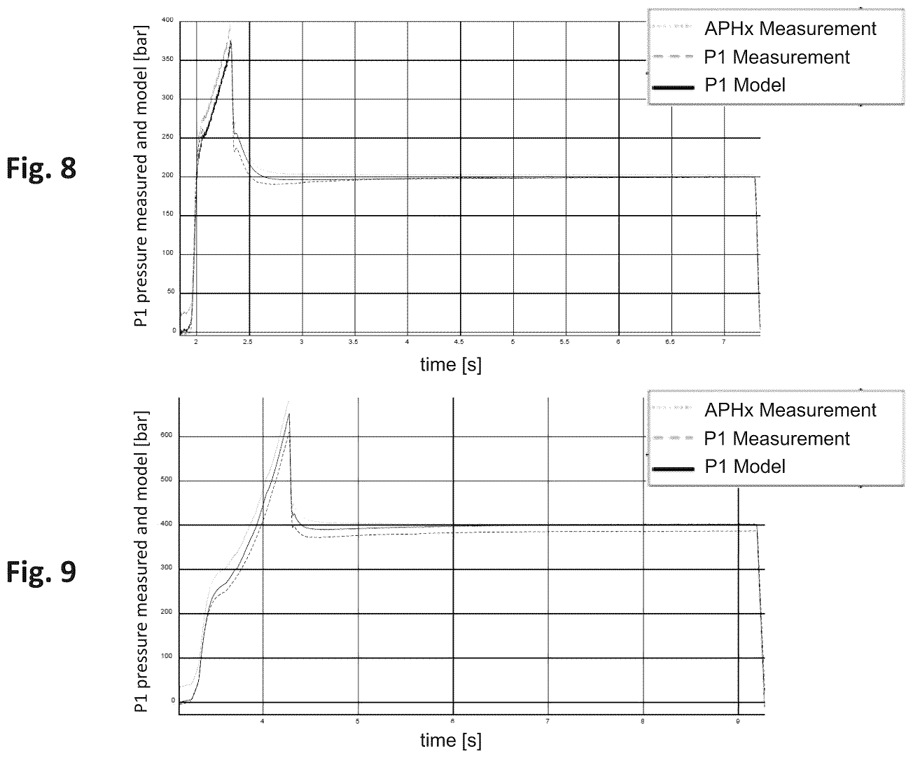

The illustrations in FIGS. 6 to 9 show the measured injection pressure (via a sensor arranged in a measuring flange 25) compared to the injection pressure calculated using the above-mentioned equations (based on the recorded signal characteristic of the driving force of the injection actuator 4) for different materials and injection speeds, during the filling and holding pressure phase of an injection unit.

### LIST OF REFERENCE NUMERALS

1 injection unit
2 molding machine
3 mass cylinder
4 injection actuator
5 injector
6 open or closed loop control device
7 essentially constant force level
8 injection force level
9 injection screw
10 longitudinal axis
11 clamping unit
12 machine frame
13 fixed mold clamping plate
14 movable mold clamping plate
15 guide device
16 piston-cylinder unit
17 spar
18 locking nut
19 locking device
20 closing force mechanism
21 mold
22 plasticizing group
23 operating unit and/or display device
24 non-return valve
25 measuring flange
26 receptacle for pressure sensor

1. A system, comprising:
an injection unit for a molding machine, comprising:
a mass cylinder,
an injection actuator configured to expel a plasticized molding compound from the mass cylinder via an injection nozzle,
at least one sensor configured to detect a time-resolved, characteristic signal for the driving force of the injection actuator, and
an open or closed loop control device for open or closed loop control of the injection actuator, which open or closed loop control device is configured to receive the time-resolved, characteristic signal of the at least one sensor, wherein the open or closed loop control device is configured to carry out the following steps:
controlling the injection actuator to perform a movement towards the injection nozzle,
recording the time-resolved, characteristic signal of the driving force of the injection actuator,
determining a first force level that is substantially constant for a period of time before a significant increase in an injection force level follows, and
calculating a pressure loss (Δp) resulting from friction in the mass cylinder on the basis of the first force level.

2. The system of claim 1, wherein the open or closed loop control device is configured to control the injection actuator to move by a defined length in an opposite direction before detecting the time-resolved, characteristic signal and before moving in the direction of the injection nozzle.

3. The system of claim 1, wherein the open or closed loop control device is configured to detect the time-resolved, characteristic signal during a constant movement of the injection actuator in the direction of the injection nozzle at a defined speed.

4. The system of claim 1, wherein the open or closed loop control device is configured to detect a plurality of time-resolved, characteristic signals for the driving force of the injection actuator at different, defined speeds of the injection actuator for the movement in the direction of the injection nozzle, to determine a force level that is essentially constant for a period of time at each defined speed, and to calculate a pressure loss (Δp) on the basis of each force level for each defined speed.

5. The system of claim 4, wherein the open or closed loop control device is configured to reproduce the detected pressure losses (Δp) for different defined speeds via a diagram and/or an algorithm

6. The system of claim 1, wherein the open or closed loop control device is configured to supply a defined amount of plasticized plastic to the mass cylinder before the detection of the time-resolved, characteristic signal and before the movement of the injection actuator in the direction of the injection nozzle, to plasticize it by an open or closed loop controlled rotary movement of an injection screw and to collect it between the injection actuator and the injection nozzle.

7. The system of claim 1, wherein the injection actuator is configured to drive an injection piston or an injection screw linearly along a longitudinal axis in the mass cylinder for expelling the plasticized molding compound.

8. The system of claim 1, wherein the open or closed loop control device is configured to detect and calculate the pressure loss (Δp) during:
the ongoing operation of the injection unit,
the plasticized molding compound in the mass cylinder is fed into a free space via the injection nozzle through the injection actuator, and/or
the plasticized molding compound is compressed into a mass cushion in the mass cylinder with the injection nozzle closed.

9. The system of claim 1, wherein the open or closed loop control device is configured to take into account the first force level and/or the pressure loss (Δp) in a subsequent open and/or closed loop control of the injection actuator, to take into account the first force level and/or the pressure loss (Δp) in the determination of the injection force level during an injection process.

10. The system of claim 1, comprising an injection molding machine having the injection unit.

11. A method for determining the pressure loss (Δp) of the injection unit of a molding machine according to claim 1, wherein the injection unit has the mass cylinder and the injection actuator, which injection actuator is configured to expel the plasticized molding compound from the mass cylinder via the injection nozzle, comprising the following method steps:
moving the injection actuator towards the injection nozzle,
recording the time-resolved, characteristic signal of the driving force of the injection actuator,
determining the first force level that is substantially constant for the period of time before the significant increase in the injection force level follows, and
calculating the pressure loss (Δp) resulting from friction in the mass cylinder on the basis of the first force level.

12. A computer program product comprising instructions which, when the program is executed by the open or closed loop control device of the injection unit according to claim 1, carries out the following steps:
controlling the injection actuator to perform the movement towards the injection nozzle,
recording the time-resolved, characteristic signal of the driving force of the injection actuator,
determining the first force level that is substantially constant for the period of time before the significant increase in the injection force level follows, and
calculating the pressure loss (Δp) resulting from friction in the mass cylinder on the basis of the first force level.

13. A system, comprising:
a controller configured to control an injection unit for a molding machine, wherein the controller is configured to perform operations comprising:
controlling an injection actuator to perform a movement towards an injection nozzle of the injection unit, wherein the injection actuator is configured to expel a plasticized molding compound from a mass cylinder via the injection nozzle;
recording a time-resolved, characteristic signal of a driving force of the injection actuator via at least one sensor of the injection unit;
determining a first force level that is substantially constant for a period of time before a significant increase in an injection force level follows; and
calculating a pressure loss (Δp) resulting from friction in the mass cylinder on the basis of the first force level.

14. The system of claim 13, wherein the controller is configured to control the injection actuator to move by a defined length in an opposite direction before detecting the time-resolved, characteristic signal and before moving in the direction of the injection nozzle.

15. The system of claim 13, wherein the controller is configured to detect the time-resolved, characteristic signal during a constant movement of the injection actuator in the direction of the injection nozzle at a defined speed.

16. The system of claim 13, wherein the first force level is substantially constant within a threshold range for the period of time, and the significant increase in the injection force level outside of the threshold range.

17. A method, comprising:
controlling an injection unit for a molding machine, wherein controlling comprises:
controlling an injection actuator to perform a movement towards an injection nozzle of the injection unit, wherein the injection actuator is configured to expel a plasticized molding compound from a mass cylinder via the injection nozzle;
recording a time-resolved, characteristic signal of a driving force of the injection actuator via at least one sensor of the injection unit;
determining a first force level that is substantially constant for a period of time before a significant increase in an injection force level follows; and
calculating a pressure loss (Δp) resulting from friction in the mass cylinder on the basis of the first force level.

18. The method of claim 17, comprising:
controlling the injection actuator to move by a defined length in an opposite direction before detecting the time-resolved, characteristic signal and before moving in the direction of the injection nozzle; and
detecting the time-resolved, characteristic signal during a constant movement of the injection actuator in the direction of the injection nozzle at a defined speed.

19. The method of claim 17, comprising:
detecting a plurality of time-resolved, characteristic signals for the driving force of the injection actuator at different, defined speeds of the injection actuator for the movement in the direction of the injection nozzle, to determine a force level that is essentially constant for a period of time at each defined speed, and to calculate a pressure loss (Δp) on the basis of each force level for each defined speed.

20. The method of claim 17, wherein the first force level is substantially constant within a threshold range for the period of time, and the significant increase in the injection force level outside of the threshold range.
